(19) United States
(12) Patent Application Publication
(10) Pub. No.: US 2012/0310837 A1
(43) Pub. Date: Dec. 6, 2012

(54) Method and System For Providing Authenticated Access to Secure Information

(76) Inventor: Holden Kevin Rigby, Havertown, PA (US)

(21) Appl. No.: 13/488,338

(22) Filed: Jun. 4, 2012

Related U.S. Application Data
(60) Provisional application No. 61/492,829, filed on Jun. 3, 2011.

(51) Int. Cl. H04L 9/32; G06Q 50/24

(52) U.S. Cl. 705/51; 713/168

(57) ABSTRACT

A system and method for providing access to secure information. The method includes using a computing device to detect a connection between the computing device and an electronic key. The electronic key stores an encrypted unique electronic identifier (UEID). The method also includes using the computing device to authenticate a provider identifier (ID). If the provider ID is authentic and the electronic key is connected to the computing device the UEID is accessed. A request to access secure information is transmitted by the computing device to a secure storage device. Access to the secure information is granted based on the authenticated provider ID and a set of access preferences associated with the UEID. The computing device receives the requested secure information if the request is granted.

### REFERENCE TO RELATED APPLICATIONS

This application is a non-provisional application claiming priority to U.S. Provisional Patent Application Ser. No. 61/492,829, which is hereby incorporated by reference as if fully disclosed herein.

### BACKGROUND

Ready access to electronic medical records is becoming more important as electronic record storage systems become ubiquitous. Currently, patient records are stored by each individual provider. While some advances have been made to centralize electronic medical records, existing systems do not permit patients to exercise complete access control to sensitive information.

Systems have been presented that provide for multi-level authenticated access to medical records. Current systems include a portable secure medical storage and management device together with systems and methods for inputting managing and updating the records contained in the device. Mobile devices are also disclosed which can provide assistance and relay information in emergency situations. Access to the contents of the medical record and storage device is controlled using biometric sensors or other authentication means. However, these systems present a security risk by requiring medical records to be stored on the portable device. Notably, these systems provides no ability for the patient to exercise access control over who can view and/or modify the data.

Other systems exist that provide for collecting, aggregating and provided electronic medical records. Existing systems also provide for storing and displaying medical records for a particular user, transferring personal medical information, and patient management of medical records and information. However, existing systems do not provide for customized patient access control or healthcare provider access to the records using a method and system that provides patient centric security.

### SUMMARY

A system and method for providing access to secure information. The method includes using a computing device to detect a connection between the computing device and an electronic key. The electronic key stores an encrypted unique electronic identifier (UEID). The method also includes using the computing device to authenticate a provider identifier (ID). If the provider ID is authentic and the electronic key is connected to the computing device the UEID is accessed. A request to access secure information is transmitted by the computing device to a secure storage device. Access to the secure information is granted based on the authenticated provider ID and a set of access preferences associated with the UEID. The computing device receives the requested secure information if the request is granted.

In another aspect, a computing device contains computer program instructions to perform a method of providing access to secure information. The method includes using a computing device to detect a connection between the computing device and an electronic key. The electronic key stores an encrypted unique electronic identifier (UEID). The method also includes using the computing device to authenticate a provider identifier (ID). If the provider ID is authentic and the electronic key is connected to the computing device the UEID is accessed. A request to access secure information is transmitted by the computing device to a secure storage device. Access to the secure information is granted based on the authenticated provider ID and a set of access preferences associated with the UEID. The computing device receives the requested secure information if the request is granted.

In another aspect of the invention, the system includes an electronic key, a client terminal device, a secure storage device, and a provider terminal device. The client terminal device includes computer program instructions capable of instructing a processor to authenticate a user password, detect a connection between the client terminal device and the electronic key, access the UEID stored on the electronic key, and transmit a command to the secure storage device causing the secure storage device to set one or more access preferences associated with the UEID.

### BRIEF DESCRIPTION OF THE DRAWINGS

FIG. 1 is a system diagram that is helpful for understanding the invention.

FIG. 2 is a flow chart of an embodiment of a method according to the disclosure.

FIG. 3 is a flow chart of an embodiment of a method according to the disclosure.

FIGS. 4A-B illustrate example embodiments of an electronic key.

FIG. 6 is a block diagram illustrating elements that may be included in a computing device.

FIG. 5 is a block diagram illustrating elements that may be included in a secure storage device.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a”, “an”, and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

For the purposes of this disclosure, the following terms shall have the respective meanings set forth below:

A “computing device” refers to an electronic device having a processor, and a memory that performs one or more operations according to one or more programming instructions. Non-limiting examples include personal computers, laptop computers, tablet computers, and smartphones.

An “electronic key” refers to a device which is capable of being carried by a person and is preferably small enough to fit in a clothing pocket or be worn around the neck as pendant. It includes a computer readable storage medium and is capable of connecting with a computing device through any a wireless or wired connection. Non-limiting examples of a wired connection include universal serial bus (USB), mini USB, micro USB, Firewire (IEEE 1394), Ethernet, and the like. Non-limiting examples of a wireless connection include radio frequency identifier (RFID), near field communication (NFC), Bluetooth®, Wi-Fi, and the like. The computer readable storage medium on the electronic key may include a unique electronic identifier (UEID) that can be used to identify the device or the person carrying it. Non-limiting examples of the form of an electronic key are a flash memory stick, a bracelet, a pendent, a card, and the like. Some forms, e.g. a card implementation, may include a photograph of the patient for an added level of security.

A unique electronic identifier (UEID) refers to a multi character word or code that is used to uniquely identify an electronic key. The UEID may be encrypted. The UEID can be any alphanumeric code. Non-limiting examples include a serial number, an encryption key, a hexadecimal number, a binary number, and the like.

A “secure storage device” refers to a server or group of servers that securely stores data. Security features may include data encryption, multi-layer authentication, and password/electronic key protection. Notably, a secure storage device need not be a single identifiable location, rather it may be administered by a cloud storage service.

The term “secure information” refers to information or data that a client desires protect and store an a secure storage device. Secure information is intended to broadly refer to any information that the client desires to keep secure. “Confidential information” refers to information or data that is subject to an ethical, moral, legal, or any other secrecy obligation. Confidential information is intended to be a sub-category of secure information. Non-limiting examples of confidential information include medical records, legal files, non-public corporate documents, and the like.

The present disclosure provides a system and method for accessing secure and/or confidential information about an individual, i.e. the client. For example, the system and method can be used by a healthcare provider to access the medical records of an individual. As further described below, the medical and other relevant information is stored electronically in a secure location and can be accessed when needed by the client or health care providers via en electronic key. By way of example, such information could include medical information, name and address of the individual, name and contact information of relatives, allergies, medications, etc. and be accessed via the internet to be viewable on a display or other such device. Additionally, the system and method as described herein is compliant with Health Insurance Portability and Accountability Act (HIPPA) and associated regulations. The system is further compatible with the paperless electronic health record initiatives proposed by the United States Government.

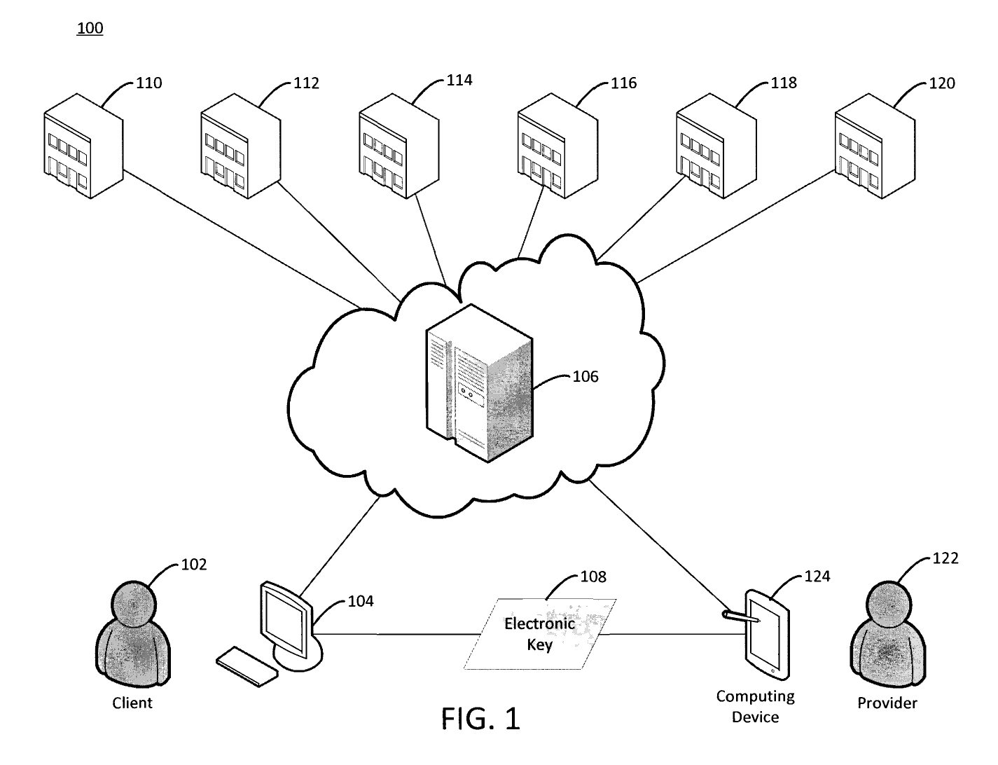

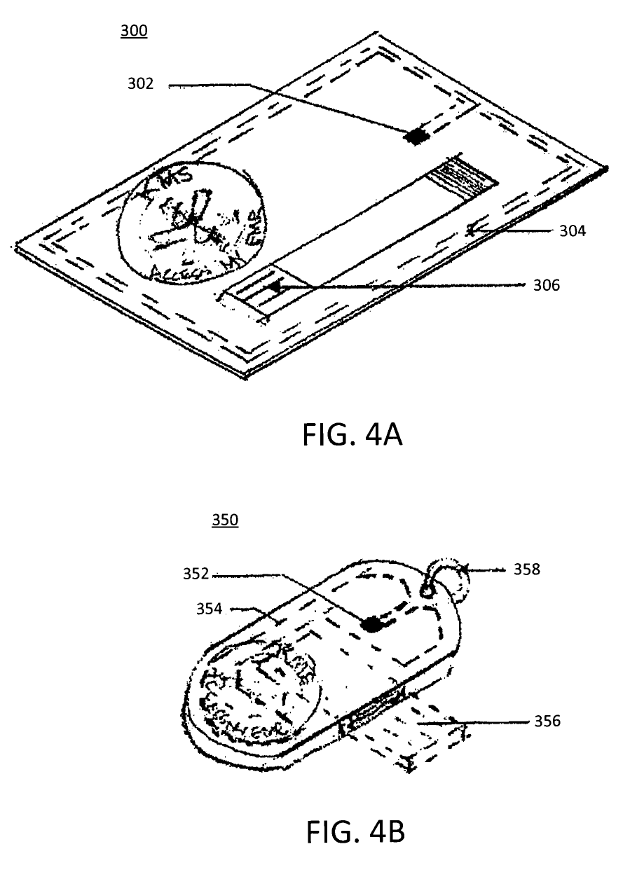

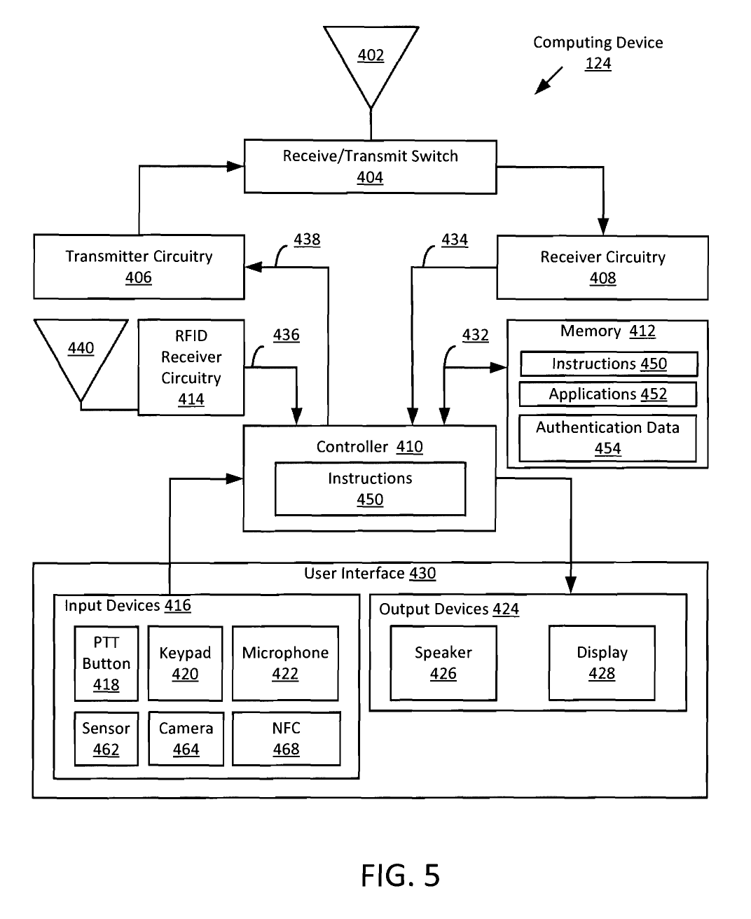

Referring to FIG. 1, a diagram of system 100 is provided. System 100 includes a client computing device 104 which may be operated by client 102. The client 102 enrolls in a secure/confidential record storage service by using client computing device 104 to access a web page. The client 102 purchases a service and receives an electronic key 108. This electronic key can be any small memory device. Non-limiting examples are shown in FIGS. 4A and 4B and are described in detail below.

System 100 also include secure storage device 106. As noted above, the secure storage device 106 can be one or more secure storage servers networked together with one or more computing devices, i.e. client computing device 104. Upon enrollment in the service, the client authorizes the storage service to collect confidential information from various entities 110-120 that possess such secure/confidential information. In the example of medical records, entities 110-120 may be healthcare providers such as hospitals, laboratories, doctor's offices/practices including primary care providers and specialty providers, and the like. The storage service may use the client authorization to request electronic delivery of the confidential records into secure storage device 106. Once all confidential records have been delivered, the client may log on through a web portal (not shown) using client computing device 104 and electronic key 108. The web portal may allow viewing access to the confidential records. Additionally, the portal may allow the client 102 to alter access preferences on individual files stored on secure storage device 106. Notably, the portal does not allow access to the records without a connection with the electronic key 108 and a proper client login.

Also included in system 100 is computing device 124 which may be operated by provider 122. Provider 122 can connect computing device and electronic key 108 and log on to a portal with an authentic provider identifier (ID) to view client files. The provider's access to client's files on secure storage device 106 is defined by and based on a set of access preferences set by the client 102. The access preferences separate the confidential files stored on secure storage device 106 between a “common” tier and a “secure” tier. Regardless of the tier the confidential information belongs to, the provider must have portable device 108 connected to computing device 124 and have an authentic provider ID to view access any confidential information. For common tier information (i.e. records with a record type of “common”), this is all that is required to view the information. For secure tier information (i.e. records with a record type of “secure”), however, the client 102 must also supply a client password to allow the provider access to the information through computing device 124. In addition to the security tiers just described, the client 102 can also allow or deny access to individual provider IDs.

In an example, client 102 contracts with a storage service to store confidential medical records on secure storage device 106. The storage service receives authorization from client 102 to request and receive the client's confidential medical files from provider's 110-120. After the records have been received by the storage service and stored on secure storage device 106, the client may connect the electronic key 108 to client computer 104 and log on to a portal on client computer 104 to view the stored files and to change the access privileges on individual records. The client may wish basic information to be available in a common security tier. Non-limiting examples of such basic information include blood type, details of current prescription medications, preexisting and/or previously diagnosed health conditions, allergies, and the like. However, the client may wish to have other types of medical information to be available only via a secure security tier. This information may include any information that is not relevant or required for emergency care.

In this example, a client 102 arrives at an emergency room and is treated by provider 122 utilizing computing device 124. The client is carrying electronic key 108. Provider 122 locates electronic key 108 and connects it to computing device 124. Provider 122 enters a provider ID to authenticate provider as genuine and is provided access to the medical records that client 102 has previously assigned a common record type, so long as the client has not denied access to the provider ID. If the provider 122 requires access to any files that the client 102 has assigned a secure record type, the provider 122 must have the client's password.

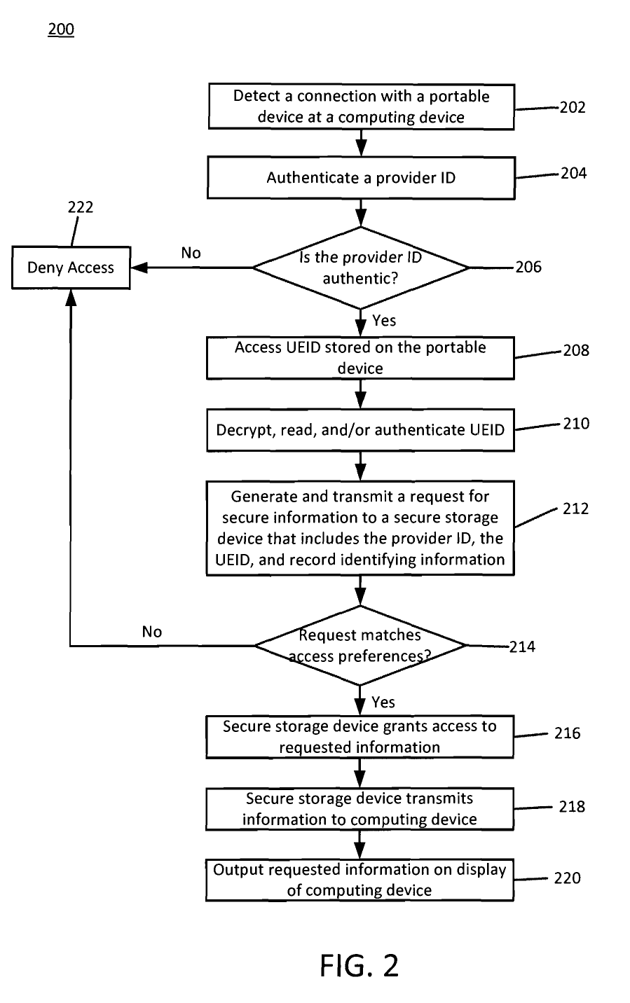

Referring now to FIG. 2, a flow chart of a process 200 is provided. The process described in FIG. 2 is a method of providing access to secure information through a computing device. For example, process 200 may be implemented on computing device 124 of FIG. 1. The process 200 begins with the computing device detecting a connection with a portable device 202. This connection may be through a wired or wireless communication interface. For example, the portable device may have a USB connector that is inserted into a USB port on the computing device. Methods of automatically detecting and recognizing a USB device exist within the art and will not be described in further detail. Alternatively, the portable device may have an RFID capability that is capable of being read by the computing device. Although USB and RFID embodiments are described above, any wireless or wired connection may be used without limitation.

After a connection with the portable device has been detected, a provider ID is authenticated 204. Authentication techniques are well established within the art and will not be described in further detail. Any technique that provides sufficient confidence that the provider ID is genuine and accurately identifies the provider may be used without limitation. Non-limiting examples include password or personal identification number access, biometric access, and/or physical or electronic key access.

If the provider ID fails authentication, i.e. is not authentic, access is denied 222. If the provider ID is authentic, the computing device is allowed to access the UEID that is stored on the electronic key 208. The UEID may be encrypted. If so, the computing device decrypts the UEID 210. Additionally, the computing device may also authenticate the UEID. UEID authentication may be accomplished in the same or a similar way to provider ID authentication, although any method of authentication may be used without limitation.

The computing device reads the UEID and generates a request for secure information 212. The request for confidential information may be encrypted. Additionally, the request may include the UEID read from the electronic key, the authenticated provider ID, and identifying information which identifies a requested portion of the secure information. The requested portion can be any portion of the secure information, up to and including all of the secure information.

After the request for secure information is generated, the request is transmitted to a secure storage device 212. The secure storage device may be a particular storage device connected to the computing device or may be a remote storage device. In an example, the secure storage device is a cloud-based storage system that is connected to the computing device through the Internet. The secure storage device receives the request and compares it to a set of access preferences previously established by the client. If the request does not match any of the access preferences, access is denied 222. However, if the request does match at least one of the access preferences, access is granted to the requested information 216. The secure storage device then transmits the requested information back to the computing device 218. The computing device then outputs the requested information on a display connected to the computing device for use by the provider.

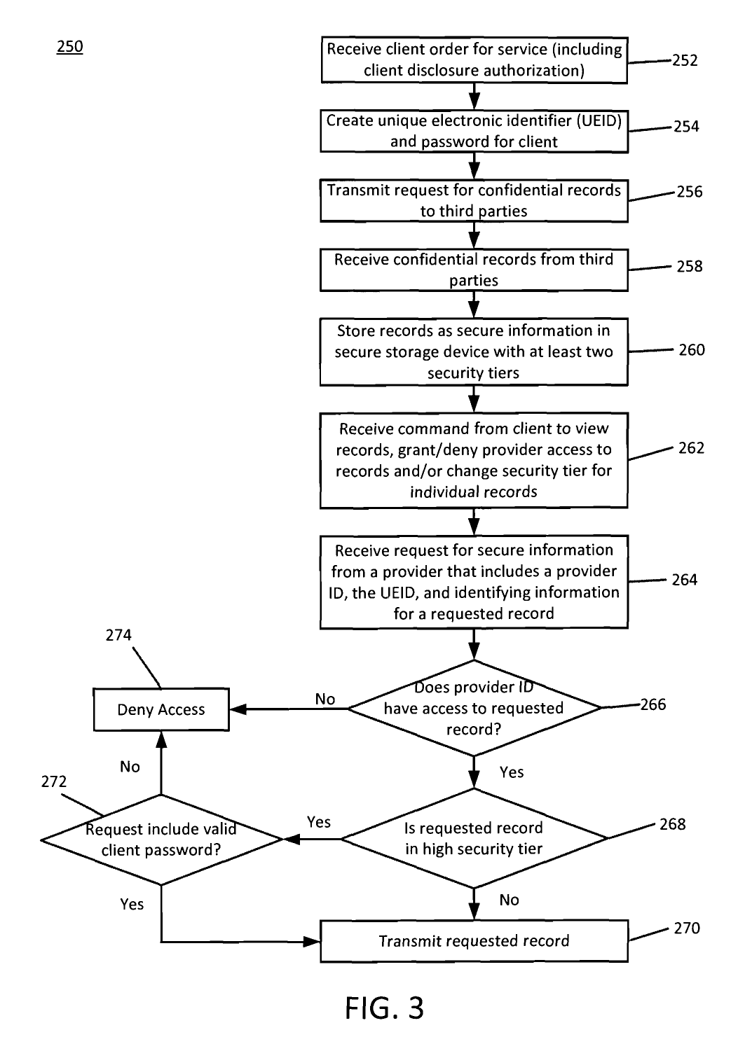

Referring now to FIG. 3, a flow chart illustrating a process 250 is provided. Process 250 describes a method of securely storing and controlling access to secure information. For example, process 250 may be implemented on secure storage device 106 of FIG. 1. The process 250 begins with a client order for storage service being received 252. The client order for storage service may also include client disclosure authorization. If so, the storage service is authorized to request secure and confidential information from various providers.

The secure storage device then creates a unique electronic identifier (UEID) and assigns it to the client 254. A password is also generated that allows secure client access to the records to be stored on the secure storage device. The password may be automatically generated (and the client then allowed to change the password as they choose) or may be generated by the client through the registration and purchase process.

The secure storage service/device then generates and transmits a request for secure records to various third parties identified by the client 256. This request can be generated in any format suitable for transmission to third parties. Non-limiting examples include electronic mail, facsimile, and printouts shipped to third parties using United States Postal Service or other delivery service. In response to the request for secure records, the secure storage device receives the secure records from the third parties 258. The records are then stored on the secure storage device 260. The records may be placed in at least two security tiers, e.g. a common tier corresponding to a common record type and a secure tier corresponding to a secure record type. As described above, the security tier in which a particular record is placed is ultimately at the discretion of the client. Additionally, the client has rights to edit the access preferences for a particular record.

The client interacts with the secure storage device through a terminal. This terminal may be client computing device 104 of FIG. 1. The client may have access to the secure storage device through a portal provided by a website, for example. The client generates a command to view and/or change the access preferences for one or more of the secure records stored on the secure storage device 262. The command is received by the secure storage device and is executed. For example, the client may wish to give a particular provider access rights to the secure information. Alternatively, the client may wish to deny a particular provider access rights to any information.

Providers also have access to the secure storage device. As noted above, specific access may be granted or denied through client access preferences. A request from a provider for secure information is received 264. The request may include a provider ID, a UEID and identifying information that identifies a requested portion of the secure information. The requested portion may be a single record, multiple records, or all records. The secure storage device determines whether the provider ID has been granted access to the requested record 266. Alternatively, the secure storage device may determine whether the provider ID has been denied access to the requested record. One of skill in the art will note that the default behavior of the secure storage system could be either permitting or denying access absent affirmative action by the client. In any case, if the provider ID does not have access to the record, access is denied. 274.

If the provider does have access to the record, the secure storage device then determines whether the requested record is in a high security tier, i.e. whether the requested record has a secure or a common record type 268. If the record is not in a high security tier, i.e. is of a common record type, the secure storage device transmits the record 270. If, however, the requested record is in a high security tier, i.e. is in of a secure record type, secure storage device determines whether the request includes a valid client password 272. If a valid client password is included in the request, the secure storage device transmits the record 270. If the client password is not valid, or if there is no client password in the request, access is denied 274.

Referring now to FIGS. 4A and 4B, non-limiting examples of an electronic key are provided. FIG. 4A illustrates electronic key 300. Electronic key 300 is in the approximate shape and size of a credit card and includes an RFID circuit 302 and an RFID antenna 304. Additionally, electronic key 300 includes a USB connector 306. As can be seen from FIG. 4A, the USB connector folds into the card-like device. Referring to FIG. 4B, electronic key 350 is shown. In this alternative implementation, electronic key 350 includes an RFID circuit 352 and an RFID antenna 354. Electronic key 350 also includes USB connector 356. In this example, electronic key 350 is a pendent that can be connected to a chain through ring 358. The examples illustrated in FIGS. 4A and 4B are not to be considered limiting.

Referring now to FIG. 5, there is provided a detailed block diagram of the computing device 124. The computing device 124 will be described herein as comprising a tablet computer. However, the present invention is not limited in this regard. For example, the computing device can alternatively comprise a notebook, a laptop computer, a PDA, a smart phone, or other device.

Notably, the computing device 124 can include more or less components than those shown in FIG. 5. For example, the computing device 124 can include a wired system interface, such as a universal serial bus interface (not depicted). However, the components shown are sufficient to disclose an illustrative embodiment implementing the present invention. The hardware architecture of FIG. 5 represents one embodiment of a representative computing device configured to facilitate the provision of automatic vehicle setting control service to a user thereof.

As shown in FIG. 5, the computing device 124 includes an antenna 402 for receiving and transmitting Radio Frequency (RF) signals. A receive/transmit (Rx/Tx) switch 404 selectively couples the antenna 402 to the transmitter circuitry 406 and receiver circuitry 408 in a manner familiar to those skilled in the art. Computing device may include receiver circuitry 408 which demodulates and decodes the RF signals received from a network to derive information therefrom. The receiver circuitry 408 is coupled to a controller 410 via an electrical connection 434. The receiver circuitry 408 provides the decoded RF signal information to the controller 410. The controller 410 uses the decoded RF signal information in accordance with the function(s) of the computing device 124. The controller 410 also provides information to the transmitter circuitry 406 for encoding and modulating information into RF signals. Accordingly, the controller 410 is coupled to the transmitter circuitry 406 via an electrical connection 438. The transmitter circuitry 406 communicates the RF signals to the antenna 402 for transmission to an external device (e.g., network equipment of a network not depicted in FIG. 4).

Similarly, the computing device may be RFID-enabled. An RFID-enabled computing device 124 includes, an antenna 440 coupled to RFID receiver circuitry 414 for receiving RFID signals. The RFID receiver circuitry 414 demodulates and decodes the RFID signals for the controller 410 to extract information therefrom. As such, the RFID receiver circuitry 414 is coupled to the controller 410 via an electrical connection 436. Notably, the implementations are not limited to RFID based methods for communication. Other methods for communicating between computing devices may be used with the various implementations without limitation.

The controller 410 uses the decoded RFID information in accordance with the function(s) of the computing device 124. For example, the RFID information and/or other received information can be used to authenticate a provider ID, read and authenticate a UEID, and the like.

The controller 410 stores the decoded RF signal information and the decoded RFID information in a memory 412 of the computing device 106. Accordingly, the memory 412 is connected to and accessible by the controller 410 through an electrical connection 432. The memory 412 can be a volatile memory and/or a non-volatile memory. For example, the memory 412 can include, but is not limited to, a Random Access Memory (RAM), a Dynamic Random Access Memory (DRAM), a Static Random Access Memory (SRAM), Read-Only Memory (ROM) and flash memory. The memory 412 can also have stored therein the software applications 452 and user-defined rules 454.

The software applications 452 may include, but are not limited to, applications operative to provide secure access services to storage devices. The software applications 452 are also be operative to accomplish any other function of computing device 124. The authentication data 454 may comprise information identifying the client, provider, and/or operator of the computing device 124. More specifically, at least one of the user-defined settings 454 includes one or more setting preferences that authenticate a provider ID and/or a UEID.

As shown in FIG. 4, one or more sets of instructions 450 are stored in the memory 412. The instructions 450 can also reside, completely or at least partially, within the controller 410 during execution thereof by the computing device 106. In this regard, the memory 412 and the controller 410 can constitute machine-readable media. The term “machine-readable media”, as used here, refers to a single medium or multiple media that store the one or more sets of instructions 450. The term “machine-readable media”, as used here, also refers to any medium that is capable of storing, encoding or carrying the set of instructions 450 for execution by the computing device 124 and that cause the computing device 124 to perform one or more of the methodologies of the present disclosure.

The controller 410 is also connected to a user interface 430. The user interface 430 is comprised of input devices 416, output devices 424, and software routines (not shown in FIG. 4) configured to allow a user to interact with and control software applications 452 installed on the computing device 124. Such input and output devices respectively include, but are not limited to, a display 428, a speaker 426, a keypad 420, a directional pad (not shown in FIG. 4), a directional knob (not shown in FIG. 4), a microphone 422, a Push-To-Talk (“PTT”) button 418, sensors 462, a camera 464 and a Bluetooth® or NFC transceiver 468.

The microphone 422 facilitates the capturing of sound and converting the captured sound into electrical signals. The computing device 124 may also include various sensors 462. The camera 464 facilitates the capturing of images and video automatically or in response to a user-software interaction. Embodiments are not limited in this regard.

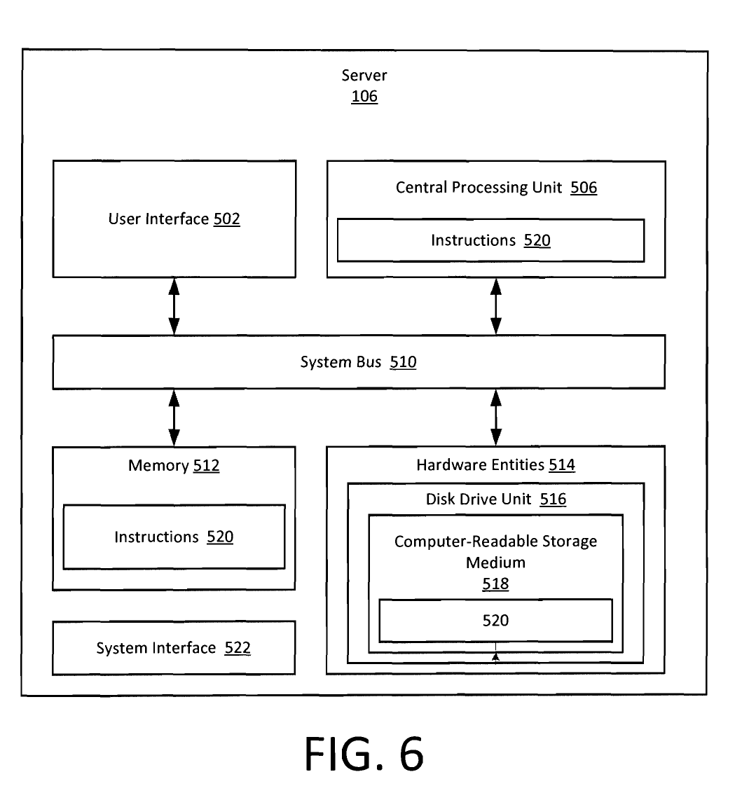

Referring now to FIG. 6, there is provided a more detailed block diagram of the secure storage device 106 of FIG. 1 that is useful for understanding the present invention. As shown in FIG. 6, the secure storage device 106 comprises a system interface 522, a user interface 502, a Central Processing Unit (CPU) 506, a system bus 510, a memory 512 connected to and accessible by other portions of secure storage device 106 through system bus 510, and hardware entities 514 connected to system bus 510. At least some of the hardware entities 514 perform actions involving access to and use of memory 512, which can be a Random Access Memory (RAM), a disk driver and/or a Compact Disc Read Only Memory (CD-ROM). Some or all of the listed components 502-522 can be implemented as hardware, software and/or a combination of hardware and software. The hardware includes, but is not limited to, an electronic circuit.

The secure storage device 106 may include more, less or different components than those illustrated in FIG. 6. However, the components shown are sufficient to disclose an illustrative embodiment implementing the present invention. The hardware architecture of FIG. 6 represents one embodiment of a representative secure storage device configured to facilitate the provision of automatic software function control services to a user of a computing device (e.g., client computing device 104 and/or computing device 124 of FIG. 1). As such, the secure storage device 106 includes an electronic circuit which implements a method for providing secure access to secure and/or confidential records stored thereon.

Hardware entities 514 can include microprocessors, Application Specific Integrated Circuits (ASICs) and other hardware. It should be understood that the microprocessor can access and run various software applications (not shown in FIG. 6) installed on the secure storage device 106.

As shown in FIG. 6, the hardware entities 514 can include a disk drive unit 516 comprising a computer-readable storage medium 518 on which is stored one or more sets of instructions 520 (e.g., software code or code sections) configured to implement one or more of the methodologies, procedures, or functions described herein. The instructions 520 may also reside, completely or at least partially, within the memory 512 and/or within the CPU 506 during execution thereof by the secure storage device 106. The memory 512 and the CPU 506 also may constitute machine-readable media. The term “machine-readable media”, as used here, refers to a single medium or multiple media (e.g., a centralized or distributed database, and/or associated caches and servers) that store the one or more sets of instructions 520. The term “machine-readable media”, as used here, also refers to any non-transient medium that is capable of storing, encoding or carrying a set of instructions 520 for execution by the secure storage device 106 and that cause the secure storage device 106 to perform any one or more of the methodologies of the present disclosure.

System interface 522 allows the secure storage device 106 to communicate directly or indirectly with external computing devices (e.g., client computing device 104 and/or computing device 124 of FIG. 1). If the secure storage device 106 is communicating indirectly with the external computing device, then the secure storage device 106 is sending and receiving communications through a common network (e.g., client computing device 104 and/or computing device 124 of FIG. 1).

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for providing access to secure information, the method comprising:
a) detecting a connection between a computing device and an electronic key which stores an encrypted unique electronic identifier (UEID);
b) authenticating on said computing device a provider identifier (ID);
on conditions: (i) that said provider ID is authentic and (ii) that said electronic key is connected to said computing device,
c) accessing by said computing device said UEID which is stored on said electronic key through said connection;
d) transmitting by said computing device to a secure storage device which stores secure information a request to access at least a portion of said secure information in which access to said secure information is granted based on an authenticated provider ID and a set of access preferences associated with said UEID; and
e) receiving by said computing device from said secure storage device said portion of said secure information in response to said request.

2. The method of claim 1, in which accessing said UEID further comprises:
decrypting said UEID;
reading a decrypted UEID;
authenticating said decrypted UEID; and
encrypting an authenticated UEID for transmission to said secure storage device.

3. The method of claim 2, in which said request to access a portion of said secure information comprises:
an encrypted authenticated UEID;
an authenticated provider ID; and
information which identifies a requested portion of said secure information.

4. The method of claim 3, in which said information comprises at least one record type and at least one record ID.

5. The method of claim 4, in which said record type is a common record type or a secure record type.

6. The method of claim 5, in which said set of access preferences comprises a table which relates a record ID, a record type, and a provider ID.

7. The method of claim 6, in which access to said secure information is granted on the conditions that
said provider ID is authorized to view said requested portion of said secure information,
said requested portion of said secure information has a common record type, and
said request for a portion of said secure information matches one or more access preferences.

8. The method of claim 7, in which access to said secure information is granted on the conditions that
said requested portion of said secure information has a secure record type, and
said request for a portion of said secure information matches one or more access preferences and includes a valid client password.

9. A computing device comprising:
a processor;
a display; and
a computer-readable storage device which contains a computer program which is capable of providing authenticated access to secure information and which comprises programming instructions that are capable of instructing the processor:
a) to authenticate a provider identifier (ID);
b) to detect a connection between said computing device and an electronic key which stores an encrypted unique electronic identifier (UEID); and
on conditions: (i) that said provider ID is authentic and (ii) that said electronic key is connected to said computing device,
c) to access said UEID stored on said portable device;
d) to initiate a connection with a secure storage device which stores secure information;
e) to cause a request to access at least a portion of said secure information to be transmitted to said secure storage device, in which access to said secure information is granted based on an authenticated provider ID and a set of access preferences associated with said UEID; and
f) to output said secure information to said display after a response to said request is received.

10. The computing device of claim 9, in which the computer-readable storage device further includes program instructions capable of instructing the processor to perform the steps of:
decrypt said UEID;
read a decrypted UEID;
authenticate said decrypted UEID; and
encrypt an authenticated UEID for transmission to said secure storage device.

11. The computing device of claim 10, where said request to access a portion of said secure information comprises:
an encrypted authenticated UEID;
an authenticated provider ID; and
information which identifies said requested portion of said secure information.

12. The computing device of claim 11, wherein said information comprises at least one record type and at least one record ID.

13. The computing device of claim 12, wherein said record type is a common record or a secure record.

14. The computing device of claim 13, wherein said set of access preferences comprise a table which relates a record ID, a record type, and a provider ID.

15. The computing device of claim 14, wherein access to said secure information is granted on the conditions that,
said provider ID is authorized to view said requested portion of said secure information,
said requested portion of said secure information has a common record type, and
said request for a portion of said secure information matches one or more access preferences and includes a valid client password.

16. The computing device of claim 15, wherein access to said secure information is granted on the conditions that,
said requested portion of said secure information has a secure record type, and
said request for a portion of said secure information matches one or more access preferences and includes a valid client password.

17. A medical information system comprising:
an electronic key which is capable of being carried by a client and which is capable also of storing an encrypted unique electronic identifier (UEID);
a client terminal device which is capable of being in communication with said electronic key and which comprises a first processor, a display, and a first computer-readable storage medium; and
a secure storage device which is capable of communicating with said computing device and which stores confidential medical information and which comprises a second processor and a first computer-readable storage medium;
said first computer-readable storage medium including program instructions which are capable of instructing the second processor to:
authenticate a user password;
detect a connection between said client terminal device and said electronic key;
access said UEID which is stored on said electronic key; and
transmit a command to said secure storage device which is capable of causing said secure storage device to set one or more access preferences associated with said UEID.

18. The medical information system of claim 19, further comprising:
a provider terminal, capable of communicating with said electronic key, and which comprises a third processor and a third computer-readable storage medium, said third computer-readable medium including program instructions which are capable of instructing the third processor to:
authenticate a provider ID;
detect a connection with said electronic key;
access said UEID stored on said electronic key;
transmit a request to access a portion of said secure information which includes an authenticated provider ID, said UEID, and identifying information which identifies said portion of said secure information; and
display a portion of said secure information after receiving a response to said request.

19. The medical information system of claim 18, in which said second computer-readable storage medium further includes program instructions that are capable of instructing said second processor to grant access to said requested portion of said confidential medical information on conditions that:
said provider ID is authorized to view said requested portion of said confidential medical information,
said requested portion of said confidential medical information has a common record type, and
said request for at least a portion of said confidential medical information matches one or more access preferences.

20. The medical information system of claim 19, wherein said second computer readable storage medium further includes program instructions which instruct said second processor to grant access to said requested portion of said confidential medical information on conditions that:
said provider ID is authorized to view said requested portion of said confidential medical information,
said requested portion of said confidential medical information has a secure record type, and
said request for at least a portion of said confidential medical information matches one or more access preferences and includes a valid client password.
